(19) United States
(12) Patent Application Publication
(10) Pub. No.: US 2022/0319273 A1
(43) Pub. Date: Oct. 6, 2022

(54) LOTTERY ASSEMBLY AND PACKAGING DEVICE

(71) Applicant: Shenzhen Ficus Technology Holdings Limited, Shenzhen, (CN)

(72) Inventors: Theresa WOO, Shenzhen (CN); Ting CHAN, Shenzhen (CN); King Shan Karen CHAN, Shenzhen (CN); King On Anthony CHAN, Shenzhen (CN); Emma Sophia Chan KAST, Shenzhen (CN); Ka Chun Kevin CHEUK, Shenzhen (CN)

(73) Assignee: Shenzhen Ficus Technology Holdings Limited, Shenzhen (CN)

(21) Appl. No.: 17/708,867

(22) Filed: Mar. 30, 2022

(30) Foreign Application Priority Data
Mar. 31, 2021 (CN) 202120666356.4

(51) Int. Cl. G07F 17/32

(52) U.S. Cl. CPC G07F 17/3241; G07F 17/329

(57) ABSTRACT

A lottery assembly and a packaging device are provided. The lottery assembly includes a lottery portion and a code portion, the code portion is provided with a first code area at a side surface thereof, and the lottery portion includes a lottery area and a second code area. The code portion is separated from the lottery portion. First information of the first code area is in correspondence with second information of the lottery portion, and the first information of the first code area is in correspondence with third information of the second code area. The packaging device includes a housing and the above lottery assembly, and the housing defines an accommodation space for accommodating a commodity. The lottery portion is arranged in the accommodation space, and at least part of the code portion is provided at an outer side of the housing to expose the first code area.

### CROSS-REFERENCE TO RELATED APPLICATIONS

The present application claims priority to Chinese Utility Model Application No. 202120666356.4, filed on Mar. 31, 2021, the content of which is incorporated herein by reference in its entirety.

### TECHNICAL FIELD

Embodiments of the present disclosure relate to the field of commodity packaging, and in particular to a lottery assembly and a packaging device having the lottery assembly.

### BACKGROUND

Manufacturers are paying increasing attention to anti-counterfeiting of commodities, especially high-end commodities. Various anti-counterfeiting measures such as barcode and laser trademark are applied at the commodities, but the commodities are still constantly counterfeited. It is difficult for consumers to identify the authenticity of anti-counterfeiting measures, and some of the anti-counterfeiting measures are easily counterfeited. If the manufacturer cannot find the counterfeit products in the market in real time, the counterfeiter will have the opportunity to counterfeit commodities.

A solution has been proposed to provide an anti-counterfeiting lottery on an outer package of a commodity. However, the anti-counterfeiting lottery may cover an obvious area of the outer package so as to obscure the information displayed on the outer package. Further, the existing outer package of the commodity may be required to be modified in order to provide the anti-counterfeiting lottery.

### SUMMARY

An aspect of embodiments of the present disclosure provides a lottery assembly. The lottery assembly includes: a code portion provided with a first code area arranged at a side surface of the code portion; and a lottery portion including a lottery area and a second code area. The code portion is arranged to be separated from the lottery portion. The first code area includes first information in correspondence with second information included in the lottery portion, and the first information is in correspondence with third information included in the second code area.

Another aspect of embodiments of the present disclosure provides a packaging device. The packaging device includes a housing and the above lottery assembly, and the housing is configured to define an accommodation space for accommodating a commodity. The lottery portion is arranged in the accommodation space, and at least part of the code portion is arranged at an outer side of the housing to expose the first code area.

### BRIEF DESCRIPTION OF DRAWINGS

These and other features and advantages of various embodiments of the present disclosure can be understood by the following description and the drawings, in which the same reference numerals refer to the same components.

FIG. 1 is a schematic diagram of a lottery assembly according to an exemplary embodiment of the present disclosure, in which a lottery portion and a code portion are not physically connected with each other;

FIG. 2 is a schematic diagram of a packaging device according to an exemplary embodiment of the present disclosure, in which a code portion is shown;

FIG. 3 is a schematic diagram of a packaging device according to an exemplary embodiment of the present disclosure, in which a code portion and a lottery portion are shown, and there is no connecting portion to physically connect the code portion and the lottery portion; and

FIG. 4 is a schematic diagram of a lottery portion according to an exemplary embodiment of the present disclosure, in which an adhesive layer is shown.

### DESCRIPTION OF EMBODIMENTS

The technical solutions of the present disclosure are further specifically described below with reference to the embodiments and the drawings. The following description of the embodiments of the present disclosure with reference to the drawings is intended to explain the general concept of the present disclosure, and should not be construed as a limitation on the present disclosure.

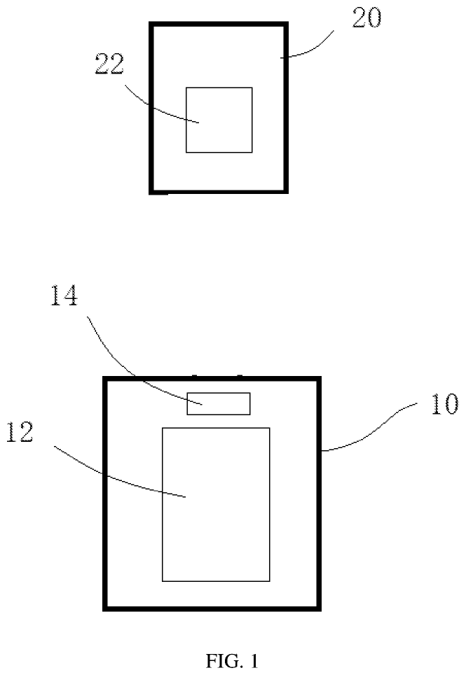

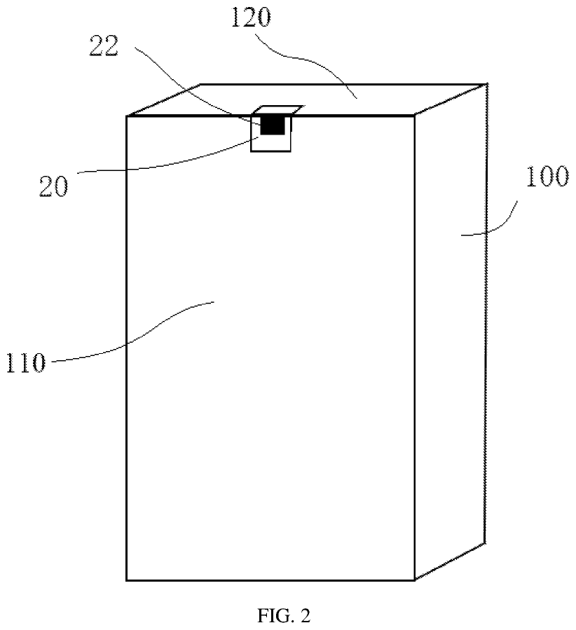

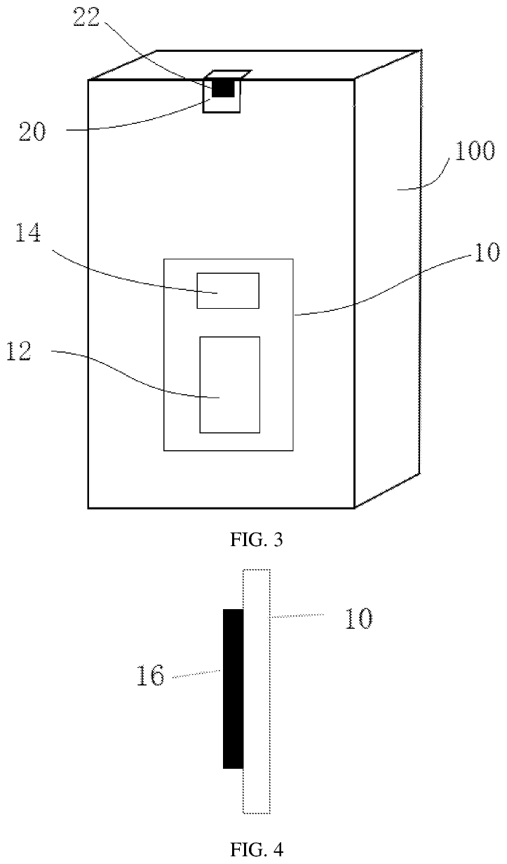

FIG. 1 is a schematic diagram of a lottery assembly according to an exemplary embodiment of the present disclosure. FIG. 2 is a schematic diagram of a packaging device according to an exemplary embodiment of the present disclosure, in which a code portion 20 is shown. FIG. 3 is a schematic diagram of a packaging device according to an exemplary embodiment of the present disclosure, in which a code portion and a lottery portion are shown, and there is no connecting portion to physically connect the code portion and the lottery portion.

As shown in FIGS. 1 to 3, the lottery assembly includes a lottery portion 10 and a code portion 20. The code portion 20 is provided with a first code area 22 on a side surface thereof, and the lottery portion 10 includes a lottery area 12 and a second code area or lottery code area 14. The code portion 20 is separated from the lottery portion 10. The first code area 22 includes first information that is in a correspondence with second information included in the lottery portion. The first information of the first code area 22 also is in a correspondence with third information included in the second code area 14. As shown in FIGS. 1 and 3, the code portion 20 and the lottery portion 10 are not physically connected with each other. In this case, the lottery portion 10 is provided with a special area as the lottery code area (the second code area) 14. The third information of the lottery code area 14 is in a correspondence with the first information of the first code area 22 of the code portion 20.

In some embodiments of the present disclosure, the first information of the first code area 22 is in a correspondence with the second information of the lottery area. That is, the first information of the first code area 22 is in correspondence with identification information (for example, information corresponding to a lottery number) of the lottery area.

In some embodiments of the present disclosure, the first information of the first code area 22 is in correspondence with the third information of the second code area 14. That is, the code portion 20 is in correspondence with the lottery portion 10, and thus the code portion 20 is paired with the lottery portion 10.

In the embodiment of the present disclosure, the lottery portion is a lottery of which authenticity is identifiable. For example, the lottery may be a lottery approved and issued by a relevant state institution, and the authenticity of the lottery can be verified by the consumer through inquiry. In embodiments of the present disclosure, the form of the lottery portion is not limited as long as the lottery portion has independent identification information (corresponding to the lottery portion) and can be redeemed.

In embodiments of the present disclosure, the lottery portion 10 includes at least one of a scratch area, a lottery barcode area and a reward-redeeming barcode area, which is an effective area or a lottery area 12. For example, the lottery portion 10 includes a scratch area, a lottery barcode area, and a reward-redeeming barcode area. The lottery barcode area can be regarded as the identification information of the lottery, and the lottery and the lottery barcode are in one-to-one correspondence. The reward-redeeming barcode area is used during the reward redemption. If the reward-redeeming barcode area has been scratched, it means that the lottery has been redeemed or the lottery cannot be used for the reward redemption.

In an embodiment of the present disclosure, the lottery may employ a barcode. It should be noted that the lottery may be identified (including reward-redeeming identification) through numbers or other identification methods.

In embodiments of the present disclosure, the first code area of the code portion 20 is provided with a barcode, a quick response (QR) code, or other code that can be scanned or identified, all of which fall within the scope of the present disclosure. In an embodiment, the first code area includes a QR code.

The dimension of the code portion 20 is not limited in the present disclosure, as long as it is convenient for a user or consumer to acquire the first information in the code area 22.

In an embodiment of the present disclosure, except for the first code area 22 corresponding to the lottery portion, the code portion 20 is further provided with an anti-counterfeiting mark. The anti-counterfeiting mark may be separated from the first code area 22, or may overlap with the first code area 22.

In an embodiment of the present disclosure, the code portion 20 is provided with the first code area 22 or the first code area 22 and the anti-counterfeiting mark at a side surface thereof, and is provided with an adhesive at another side surface to adhere the code portion 20 on a package.

As shown in FIGS. 2 and 3, the packaging device includes a housing 100. The housing 100 defines an accommodation space for accommodating a commodity. The housing 100 is provided with an unpacking portion. In an embodiment shown in FIG. 2, the housing 100 may be torn from a ridgeline, which corresponds to the unpacking portion. In an embodiment, the ridgeline is processed by weakening a strength thereof. In other words, the unpacking portion includes an unpacking line, which is configured to be split or broken based on relative movement of portions of the housing located at two sides of the unpacking line. The unpacking portion is configured to be broken to take the commodity out of the accommodation space.

As shown in FIGS. 2 and 3, the code portion 20 covers at least part of the unpacking portion.

It should be noted that the unpacking portion is not limited to the ridgeline shown in FIG. 2. In an embodiment, if the housing is required to be disassembled from an end, the unpacking portion is located on an end surface of the housing. In this case, the unpacking portion may be an unpacking line provided on the end surface. For example, a part of the end surface of the housing is depressed and broken from the unpacking line by pressing down the vicinity of the unpacking line.

It should also be noted that the unpacking portion is not limited to the ridgeline or unpacking line. The unpacking portion may be a surface. In an embodiment, an end surface of the housing is the unpacking portion. In other words, the commodity may be taken out of the housing by breaking the end surface of the housing.

In addition, in an embodiment of the present disclosure, a housing 100 for packaging is provided with a sidewall 110, a bottom wall (not shown in the figures), and a cover 120. The cover 120 is configured to be opened to take the commodity out of the accommodation space. The code portion 20 covers a part of a gap between the cover 120 and the sidewall 110.

In an embodiment, for example, the housing is an outer packaging box of a wine bottle, and a top end surface of the housing above the wine bottle can be closed. In this case, after the wine bottle is placed into the accommodation space of the housing, the lottery portion 10 of the lottery assembly shown in FIG. 1 is also placed into the accommodation space, and the code portion 20 of the lottery assembly is located outside the housing. As shown in FIGS. 2 and 3, after the top end surface is closed, the code portion 20 covers a part of a gap between the top end surface and the sidewall of the housing.

In an embodiment of the present disclosure, before a lottery portion of each lottery assembly is placed into an outer package of a commodity, relevant information is entered into the first code area of the code portion 20, such as a QR code area. The relevant information includes a serial number of the lottery in the lottery portion (which, for example, corresponds to the identification information of the lottery) and commodity information of the commodity with the lottery assembly. The user or consumer can scan the QR code area through the WeChat scan function on a mobile phone to enter an online verification platform to verify the authenticity of the commodity, check the commodity information and the lottery information in the lottery assembly, and redeem reward through the lottery. That is, the user or the consumer can scan the code area of the code portion 20 to verify the authenticity of the product, check the commodity information and the lottery information in the anti-counterfeiting lottery assembly, and redeem reward through the lottery. The user or consumer can also participate in a marketing service provided by the online verification platform. That is, the first information in the first code area of the code portion 20 may include extended service information related to the commodity, which corresponds to service information on the online verification platform.

In an embodiment of the present disclosure, the code portion 20 may not have an adhesive function, and merely needs to be connected to the outer side of the housing through other elements.

In an embodiment, as shown in FIG. 4, an adhesive layer 16 is provided at a side surface of the lottery portion 10, and the adhesive layer 16 adheres the lottery portion 10 on an inner wall of the housing 100.

In view of the above description, there is further provided a packaging device. The packaging device includes a housing and the above lottery assembly. The housing defines the accommodation space for accommodating a commodity. The lottery portion is provided in the accommodation space, and at least part of the code portion is provided outside the housing to expose the first code area.

Although the embodiments of the present disclosure are described, those of ordinary skill in the art may make various changes to these embodiments without departing from the principle and spirit of the present disclosure, and the scope of the present disclosure is defined by the appended claims and equivalents thereof.

What is claimed is:

1. A lottery assembly, comprising:
a code portion provided with a first code region, the first code region being arranged at a side surface of the code portion; and
a lottery portion comprising a lottery region and a second code region,
wherein the code portion is arranged to be separated from the lottery portion; and
wherein the first code region comprises first information in correspondence with second information comprised in the lottery portion, and the first information is in correspondence with third information comprised in the second code region.

2. The lottery assembly according to claim 1, wherein the first code region comprises a quick response code or a barcode.

3. The lottery assembly according to claim 1, wherein the code portion is provided with an anti-counterfeiting region or an anti-counterfeiting mark.

4. The lottery assembly according to claim 3, wherein the anti-counterfeiting region or anti-counterfeiting mark is arranged to be separated from the first code region.

5. The lottery assembly according to claim 3, wherein the anti-counterfeiting region or anti-counterfeiting mark overlaps with at least part of the first code region.

6. The lottery assembly according to claim 1, wherein the lottery region and the second code region are provided at a side surface of the lottery portion, and a lottery adhesive layer is provided at another side surface of the lottery portion.

7. The lottery assembly according to claim 1, wherein a code portion adhesive layer is provided at another side surface of the code portion.

8. The lottery assembly according to claim 1, wherein the first information of the first code region comprises lottery information, and the lottery information is in correspondence with lottery verification information on an online verification platform.

9. The lottery assembly according to claim 1, wherein the first information of the first code region comprises commodity information, and the commodity information is in correspondence with commodity verification information on an online verification platform; and/or
the first information of the first code region comprises extended service information related to a commodity on an online verification platform, and the extended service information is in correspondence with platform service information on the online verification platform.

10. A packaging device, comprising:
a housing configured to define an accommodation space for accommodating a commodity; and
a lottery assembly comprising a code portion and a lottery portion, the code portion being provided with a first code region, the first code region being arranged at a side surface of the code portion, and the lottery portion comprising a lottery region and a second code region,
wherein the code portion is arranged to be separated from the lottery portion;
wherein the first code region comprises first information in correspondence with second information comprised in the lottery portion, and the first information is in correspondence with third information comprised in the second code region;
wherein the lottery portion is arranged in the accommodation space; and
wherein at least part of the code portion is arranged at an outer side of the housing to expose the first code region.

11. The packaging device according to claim 10, wherein a code portion adhesive layer is provided at another side surface of the code portion; and
at least part of the another side surface of the code portion is adhered at the outer side of the housing.

12. The packaging device according to claim 11, wherein the housing is provided with an unpacking portion, and the unpacking portion is configured to be broken to take the commodity out of the accommodation space; and
the code portion covers at least part of the unpacking portion.

13. The packaging device according to claim 12, wherein the unpacking portion comprises an unpacking line, and the unpacking line is configured to be split or broken by relative movement of portions of the housing located at two sides of the unpacking line.

14. The packaging device according to claim 12, wherein the unpacking portion comprises an unpacking surface formed by an end surface of the housing.

15. The packaging device according to claim 11, wherein the housing is provided with a sidewall, a bottom wall, and a cover, and the cover is configured to be openable to take the commodity out of the accommodation space; and
the code portion covers a part of a gap between the cover and the sidewall.

16. The packaging device according to claim 10, wherein the first information of the first code region is in correspondence with information on an online platform.

17. The packaging device according to claim 16, wherein the online platform comprises an online verification platform; and
the first information of the first code region comprises lottery information, and the lottery information is in correspondence with lottery verification information on the online verification platform.

18. The packaging device according to claim 16, wherein the online platform comprises an online verification platform; and
the first information of the first code region further comprises commodity information of the commodity, and the commodity information is in correspondence with commodity verification information on the online verification platform; and/or the first information of the first code region comprises extended service information related to the commodity of the online verification platform, and the extended service information is in correspondence with platform service information on the online verification platform.
